(19) United States
(12) Patent Application Publication
(10) Pub. No.: US 2025/0321766 A1
(43) Pub. Date: Oct. 16, 2025

(54) MULTIMEDIA RESOURCE SHARING METHOD, ELECTRONIC DEVICE, AND MEDIUM

(71) Applicant: Beijing Youzhuju Network Technology Co., Ltd., Beijing (CN)

(72) Inventors: Junlin CAI, Beijing (CN); Jianqiang CHANG, Beijing (CN); Wei CAI, Beijing (CN); Li ZHANG, Beijing (CN); Haoran LI, Beijing (CN); Shengyan SHI, Beijing (CN); Kai HOU, Beijing (CN); Bo ZHU, Beijing (CN); Haozhe ZHANG, Beijing (CN); Nan KE, Beijing (CN); Jin BAI, Beijing (CN)

(21) Appl. No.: 19/177,278

(22) Filed: Apr. 11, 2025

(30) Foreign Application Priority Data
Apr. 12, 2024 (CN) 202410448075.X

(51) Int. Cl. G06F 9/451; H04L 67/02

(52) U.S. Cl. CPC G06F 9/451; H04L 67/02

(57) ABSTRACT

A multimedia resource sharing method, an electronic device and a medium. The method includes: displaying a first multimedia resource; displaying a first sharing card associated with the first multimedia resource in the first multimedia resource; in response to a trigger operation on the first sharing card, displaying a share control; and in response to a sharing operation on the share control, sending the first multimedia resource to a first sharing object indicated by the sharing operation.

### CROSS-REFERENCE TO RELATED APPLICATION

The present application claims priority to Chinese patent application No. 202410448075.X filed on Apr. 12, 2024, the disclosure of which is incorporated by reference herein in its entirety as part of the present application.

### TECHNICAL FIELD

The present disclosure relates to the field of computer technology, and in particular, to a multimedia resource sharing method and apparatus, a medium, an electronic device, and a program product.

### BACKGROUND

With the rapid development of mobile internet, people are increasingly using mobile internet for information sharing. However, in the related art, when a user performs content sharing, either a sharing entry in an application is hidden deep, or multiple operations are required to share content. The efficiency of content sharing is affected due to the complex sharing operations. Moreover, the interaction form for content sharing in the related art is relatively monotonous, making users less motivated to share content.

### SUMMARY

This Summary is provided to introduce concepts in a simplified form that are described in detail in the following Detailed Description section. This Summary section is not intended to identify key features or essential features of the claimed technical solution, nor is it intended to be used to limit the scope of the claimed technical solution.

In a first aspect, the present disclosure provides a multimedia resource sharing method, including:
displaying a first multimedia resource;
displaying a first sharing card associated with the first multimedia resource in the first multimedia resource;
in response to a trigger operation on the first sharing card, displaying a share control; and
in response to a sharing operation on the share control, sending the first multimedia resource to a first sharing object indicated by the sharing operation.

In a second aspect, the present disclosure provides a multimedia resource sharing apparatus, including:
a first display module configured to display a first multimedia resource;
a second display module configured to display a first sharing card associated with the first
multimedia resource in the first multimedia resource;
a third display module configured to display a share control in response to a trigger operation on the first sharing card; and
a sending module configured to send, in response to a sharing operation on the share control, the first multimedia resource to a first sharing object indicated by the sharing operation.

In a third aspect, the present disclosure provides a computer-readable medium storing a computer program, where the computer program, when executed by a processing apparatus, implements the steps of the method according to the first aspect.

In a fourth aspect, the present disclosure provides an electronic device, including:
a storage apparatus storing a computer program; and
a processing apparatus configured to execute the computer program in the storage apparatus to
implement the steps of the method according to the first aspect.

In a fifth aspect, the present disclosure provides a computer program product including a computer program, where the computer program, when executed by a processor, implements the steps of the method according to the first aspect.

Based on the above technical solutions, by means of displaying a first multimedia resource, displaying a first sharing card associated with the first multimedia resource in the first multimedia resource, displaying a share control in response to a trigger operation on the first sharing card, and sending the first multimedia resource to a first sharing object indicated by a sharing operation in response to the sharing operation on the share control, an interesting interactive manner between a user and a multimedia resource is provided, which not only allows a brand to carry more promotional information through the first sharing card, but also increases the user's immersion in the multimedia resource. In addition, the user can quickly share the multimedia resource with other users through the first sharing card without performing multiple operations, thereby greatly improving the user's efficiency of sharing the multimedia resource.

Other features and advantages of the present disclosure will be described in detail in the following detailed description section.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a flowchart of a multimedia resource sharing method according to some embodiments;

FIG. 2 is a schematic diagram of displaying a first sharing card according to some embodiments;

FIG. 3 is a schematic diagram of displaying a first sharing card according to other embodiments;

FIG. 4 is a schematic diagram of a share control according to some embodiments;

FIG. 5 is a schematic diagram of a second sharing card according to some embodiments;

FIG. 6 is a schematic diagram of a third sharing card according to some embodiments;

FIG. 7 is a schematic diagram of sending a first multimedia resource to a first sharing object according to some embodiments;

FIG. 8 is a schematic diagram of a structure of a multimedia resource sharing apparatus according to some embodiments; and

FIG. 9 is a schematic diagram of a structure of an electronic device according to some embodiments.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms and should not be construed as being limited to the embodiments set forth herein. Rather, these embodiments are provided for a thorough and complete understanding of the present disclosure. It should be understood that the drawings and embodiments of the present disclosure are only for exemplary purposes, and are not intended to limit the scope of the present disclosure.

It should be understood that various steps described in method implementations of the present disclosure can be performed in different orders, and/or performed in parallel. In addition, the method implementations can include additional steps and/or omit performing the illustrated steps. The scope of the present disclosure is not limited in this respect.

The term “include/comprise” used herein and the variations thereof are open-ended inclusions, namely, “include/comprise but not limited to”. The term “based on” is “at least partially based on”. The term “one embodiment” means “at least one embodiment”; the term “another embodiment” means “at least one other embodiment”; and the term “some embodiments” means “at least some embodiments”. Relevant definitions of other terms will be given in the description below.

It should be noted that concepts such as “first” and “second” mentioned in the present disclosure are only used to distinguish different apparatuses, modules, or units, and are not used to limit the order of functions performed by these apparatuses, modules, or units or interdependence between these apparatuses, modules, or units.

It should be noted that the modifications of “one” and “a plurality” mentioned in the present disclosure are illustrative rather than restrictive, and those skilled in the art should understand that unless the context clearly indicates otherwise, the modifications should be understood as “one or more”.

The names of messages or information exchanged between a plurality of apparatuses in the implementations of the present disclosure are only for illustrative purposes, and are not intended to limit the scope of these messages or information.

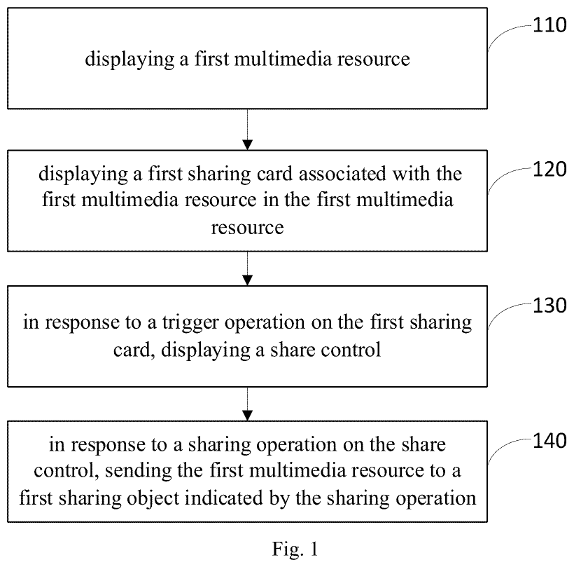

FIG. 1 is a flowchart of a multimedia resource sharing method according to some embodiments. As shown in FIG. 1, an embodiment of the present disclosure provides a multimedia resource sharing method, which can be executed by an electronic device, and in particular, can be executed by a multimedia resource sharing apparatus, which can be implemented by software and/or hardware and configured in the electronic device. As shown in FIG. 1, the method may include the following steps.
Step 110, displaying a first multimedia resource.

Here, the first multimedia resource may be a multimedia resource such as a video, a carousel picture (that is, a picture group composed of multiple pictures), and an audio, etc. The electronic device may display the first multimedia resource through a graphical user interface.

It should be understood that the first multimedia resource may be advertisement content launched by a brand. Taking a short video client as an example, the first multimedia resource may be an advertisement video in a video stream, and when the user refreshes to the advertisement video through the short video client, the advertisement video is displayed.
Step 120, displaying a first sharing card associated with the first multimedia resource in the first multimedia resource.

Here, the first sharing card may be displayed in the first multimedia resource when the first multimedia resource is displayed to a preset display node. The preset display node may be a resource node in the first multimedia resource. Taking the first multimedia resource as a video as an example, the preset display node of the first multimedia resource may refer to a video node in the video. For example, the preset display node may be the 10th second of the video, that is, the first sharing card is displayed in the video when the video is played to the 10th second.

It should be noted that the first sharing card may be a card associated with the first multimedia resource. For different first multimedia resources, the associated first sharing cards may be different. Certainly, the same first multimedia resource may be simultaneously associated with multiple different types of first sharing cards, and when the first sharing card is displayed, one first sharing card may be selected from the multiple different types of first sharing cards for display.

Taking the first multimedia resource as an advertisement video launched by a brand as an example, the brand may configure different types of first sharing cards for the advertisement video, so as to carry content that needs to be promoted through the first sharing card. When the user refreshes to the corresponding advertisement video, the corresponding first sharing card may be displayed.

It should be understood that the first sharing card may be understood as a pendant displayed in the first multimedia resource, and the first sharing card provides an entry for sharing the first multimedia resource. That is, the user may share the first multimedia resource with other users through the first sharing card.

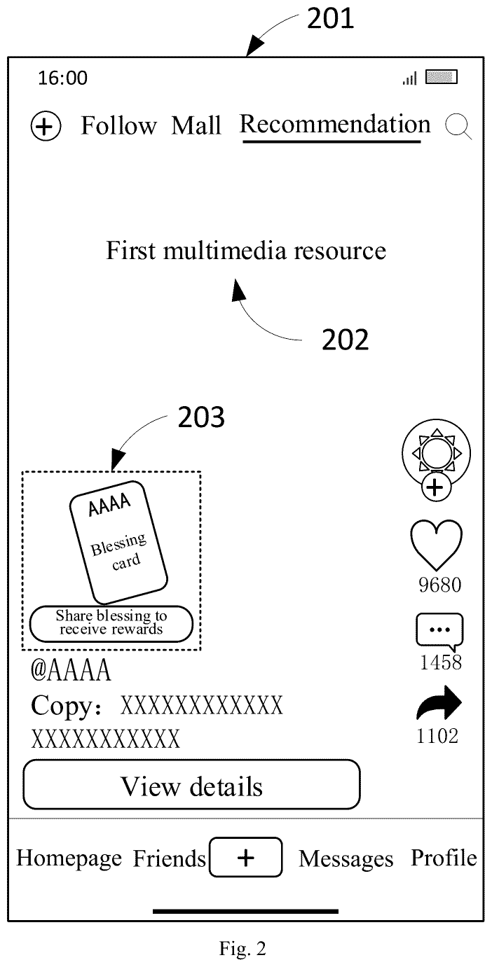

FIG. 2 is a schematic diagram of displaying the first sharing card according to some embodiments. As shown in FIG. 2, the first multimedia resource 202 is displayed through the resource display interface 201, and the first sharing card 203 is displayed when the first multimedia resource 202 is displayed to a preset display node.

It should be noted that the first sharing card 203 may be displayed in any region of the resource display interface 201, which is not specifically limited in this implementation. Moreover, the style of the first sharing card 203 may be designed according to actual situations, which is not specifically limited in this implementation.

It should be noted that the displayed first sharing card 203 may also include prompt information, as shown in FIG. 2, the prompt information may be “Share blessing to receive rewards”, so as to prompt the user to share the multimedia resource through the first sharing card 203.

In some embodiments, the first sharing card may be displayed through a preset animation effect.

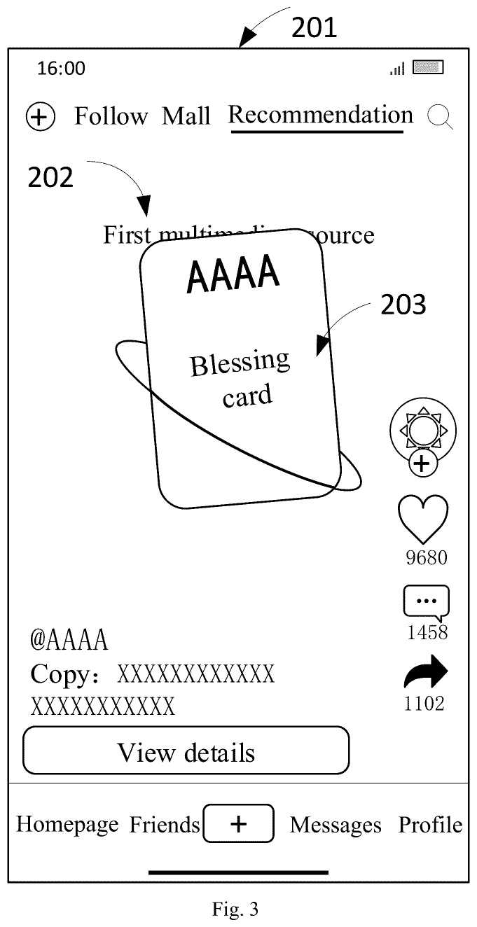

FIG. 3 is a schematic diagram of displaying the first sharing card according to other embodiments. As shown in FIG. 2 and FIG. 3, the first sharing card 203 may be first displayed in the middle position of the resource display interface 201 (as shown in FIG. 3), and then, the first sharing card 203 is moved from the middle position to the position shown in FIG. 2.

It should be noted that the first sharing card 203 may be moved from the position in FIG. 3 to the position shown in FIG. 2 through dynamic effects such as rotation and translation. In this implementation, the dynamic effect is not specifically limited, and any dynamic effect may be used according to requirements in specific implementation.

Exemplarily, the first sharing card may include description information for describing the card type to which the first sharing card belongs.

For example, the first sharing card may be a card of card type such as a blessing card, an intimate card, etc. Correspondingly, the displayed first sharing card may include the description information for describing the card type to which the first sharing card belongs. As shown in FIG. 2 and FIG. 3, the first sharing card is a blessing card, and correspondingly, the first sharing card 203 may include the text information of “blessing card”.

Certainly, the description information may be text information, or may also be information such as pictures, videos, audio, etc., which may be set according to actual application situations.

It should be noted that the brand may customize the card type corresponding to the first sharing card according to requirements, so as to meet different promotion requirements.
Step 130, in response to a trigger operation on the first sharing card, displaying a share control.

Here, the trigger operation on the first sharing card may be a click operation. For example, the user may trigger the trigger operation on the first sharing card by clicking the first sharing card. Certainly, the trigger operation on the first sharing card may also be other types of interactive operations, such as a touch-and-hold operation, a voice operation, a gesture operation, etc., which may be set according to actual situations.

When detecting the trigger operation on the first sharing card, the electronic device may display the share control in the resource display interface.

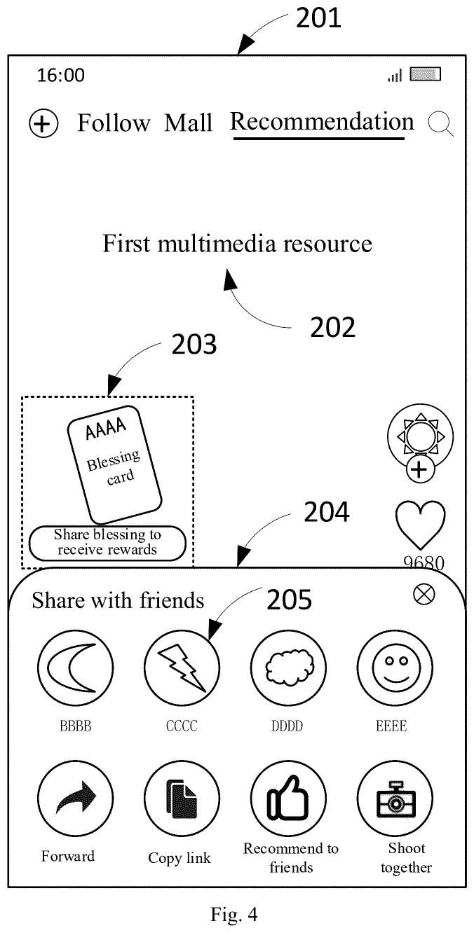

FIG. 4 is a schematic diagram of the share control according to some embodiments. As shown in FIG. 4, when the user clicks the first sharing card 203, the share control 204 may be displayed by pulling up from the bottom of the resource display interface 201. It should be noted that the share control 204 may include at least one sharing object 205. The sharing object 205 may be a friend of the user's virtual account or an object that is frequently contacted.

It should be noted that the share control 204 is actually a sharing panel for sharing the multimedia resource with other users, and the share control 204 may be a control composed of a series of sub-controls to display different sharing channels that may be selected by the user to the user.
Step 140, in response to a sharing operation on the share control, sending the first multimedia resource to a first sharing object indicated by the sharing operation.

Here, the sharing operation on the share control refers to an operation used to select the first sharing object in the share control. The sharing operation on the share control may be a click operation on the sharing object included in the share control. As shown in FIG. 4, the user may click any sharing object in the share control 204 to select the first sharing object, and share the first multimedia resource 202 with the first sharing object. For example, when the user clicks the sharing object of “CCCC”, the sharing object of “CCCC” is the first sharing object, and the first multimedia resource 202 is shared with the sharing object of “CCCC”.

It should be noted that, sending the first multimedia resource to the first sharing object indicated by the sharing operation may be sending the first multimedia resource to the first sharing object through a chat (such as a private message) with the first sharing object.

It should be noted that, if the user no longer needs to share the first multimedia resource with other users after triggering the displaying of the share control, the displaying of the share control may be stopped.

In this way, by means of displaying a first multimedia resource, displaying a first sharing card associated with the first multimedia resource in the first multimedia resource, displaying a share control in response to a trigger operation on the first sharing card, and sending the first multimedia resource to a first sharing object indicated by a sharing operation in response to a sharing operation on the share control, an interesting interactive manner between a user and a multimedia resource is provided, which not only allows a brand to carry more promotional information through the first sharing card, but also increases the user's immersion in the multimedia resource. In addition, the user can quickly share the multimedia resource with other users through the first sharing card without performing multiple operations, thereby greatly improving the user's efficiency of sharing the multimedia resource.

In some implementable implementations, when sending the first multimedia resource to the first sharing object is completed, a second sharing card corresponding to the first sharing card is displayed.

Here, completing sending the first multimedia resource to the first sharing object may refer to successfully sending the first multimedia resource to the first sharing object. Certainly, completing sending the first multimedia resource to the first sharing object may also refer to the user completing sharing the first multimedia resource with the first sharing object. For example, as shown in FIG. 4, when the user clicks any sharing object in the share control 204, it means that sending the first multimedia resource to the first sharing object is completed.

When sending the first multimedia resource to the first sharing object is completed, the electronic device may display the second sharing card associated with the first sharing card.

Exemplarily, the second sharing card includes a target image associated with the first multimedia resource and/or a target object associated with the first multimedia resource.

The target image may be a picture or a video. Taking the first multimedia resource as an advertisement video of a product as an example, the target image may be an image of the product, or the target image may also be an image of a spokesperson corresponding to the product, and so on.

The target object may be understood as a reward obtained by the user by sharing the first multimedia resource with other users. The target object may be a virtual item such as a coupon, a cash red envelope, a red envelope cover, a New Year's annual sign, etc. Certainly, the target object may also be a real item. For example, if the first multimedia resource is an advertisement video of a product, the target object may also be the product.

It should be understood that the target image and/or the target object included in the second sharing card may be configured by the brand according to requirements.

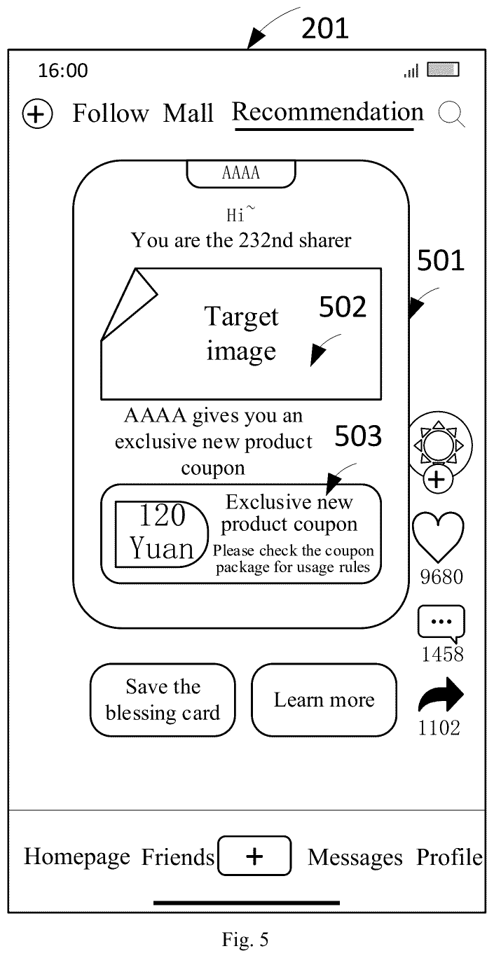

FIG. 5 is a schematic diagram of the second sharing card according to some embodiments. As shown in FIG. 5, when sending the first multimedia resource to the first sharing object is completed, the second sharing card 501 may be displayed in the resource display interface 201. The target image 502 is displayed in the first display region of the second sharing card 501, and the target object 503 is displayed in the second display region of the second sharing card 501.

It should be noted that the first sharing card and the second sharing card may be understood as the front and back of a card. For example, the first sharing card is the front of the card, and the second sharing card is the back of the card.

In this way, by means of displaying the second sharing card including the target image and/or the target object, the obtained sharing reward can be intuitively displayed to the user, thereby increasing the probability of the user sharing the second multimedia resource.

In some implementable implementations, the second sharing card may be saved locally in response to a save operation on the second sharing card.

Here, the save operation on the second sharing card refers to an operation triggered by the user to indicate that the second sharing card is to be saved locally. As shown in FIG. 5, the second sharing card 501 may include a save control (such as the “save blessing card” in FIG. 5), and when the user clicks the save control, the save operation on the second sharing card 501 is triggered.

It should be noted that, saving the second sharing card locally refers to saving the second sharing card in the electronic device. For example, the second sharing card may be saved to an album.

When detecting the save operation on the second sharing card, the electronic device saves the second sharing card locally, so that the user can permanently save the second sharing card obtained by the user by sharing the first multimedia resource.

In some embodiments, a fourth sharing card generated based on the second sharing card may be saved locally.

The fourth sharing card may be obtained by modifying the second sharing card. The fourth sharing card may be obtained by deleting or modifying part of the content in the second sharing card. For example, in the case where the second sharing card includes virtual resources such as coupons, New Year's annual signs, red envelope covers, etc. provided by the brand, part of the virtual resources in the second sharing card may be deleted or part of the virtual resources in the second sharing card may be replaced with other display elements. The other display elements may be a copy, a product image, etc. pre-configured by the brand.

Certainly, the fourth sharing card may also be obtained by adding some display elements to the second sharing card. For example, a QR code for jumping to a display page of the first multimedia resource and/or a landing page associated with the first multimedia resource may be added to the second sharing card. For another example, information about the user account sharing the fourth sharing card, such as avatar information, user nickname information, etc., may also be added to the second sharing card. In some implementable implementations, a page associated with the second sharing card is displayed in response to a page jump operation on the second sharing card.

Here, the page jump operation on the second sharing card refers to an operation triggered by the user to jump to the page associated with the second sharing card. As shown in FIG. 5, the second sharing card 501 may include a jump control (such as “Learn more” in FIG. 5), and when the user clicks the jump control, the page jump operation on the second sharing card 501 is triggered.

It should be noted that the page associated with the second sharing card may refer to a landing page corresponding to the first multimedia resource. For example, if the first multimedia resource is an advertisement video of a product, the page associated with the second sharing card may be a page of the product.

When detecting the page jump operation on the second sharing card, the electronic device displays the page associated with the second sharing card, so that the user can directly jump to the corresponding landing page through the second sharing card.

It should be noted that, displaying the page associated with the second sharing card may refer to jumping from the resource display interface to the page associated with the second sharing card.

In this way, by means of saving the second sharing card locally, and/or displaying the page associated with the second sharing card, the user can perform more interactive operations through the second sharing card, so as to save the obtained second sharing card and/or quickly jump to the corresponding page.

In some implementable implementations, the electronic device may receive a second multimedia resource shared by a second sharing object through the first sharing card.

Here, the second sharing object may refer to other user accounts other than the present user account. That is, the electronic device may share the first multimedia resource with other user accounts through the first sharing card, and may further receive the second multimedia resource shared by other user accounts through the first sharing card. The concept of the second multimedia resource is consistent with the concept of the first multimedia resource, and reference may be made to relevant descriptions of the above implementations, which will not be repeated here.

Exemplarily, the second multimedia resource shared by the second sharing object through the first sharing card may be received through a chat function with the second sharing object.

Taking a short video application as an example, the second multimedia resource shared by the second sharing object through the first sharing card may be received through a private message function of the short video application. When the second multimedia resource is received, the user may trigger the electronic device to display the second multimedia resource by clicking the second multimedia resource.

It should be noted that the received second multimedia resource shared by the second sharing object through the first sharing card may be a multimedia resource without displaying the first sharing card. That is, when displaying the received second multimedia resource shared by other users, the electronic device may no longer display the first sharing card according to the logic of the above method. Certainly, in other implementations, when displaying the received second multimedia resource shared by other users, the electronic device may display the first sharing card according to the logic of the above method.

In this way, by means of receiving the second multimedia resource shared by the second sharing object through the first sharing card, the electronic device may not only share the multimedia resource with other users, but also receive the multimedia resource shared by other users, thereby enriching the interaction forms.

In some implementable implementations, in step 140, the first multimedia resource and a third sharing card associated with the first multimedia resource may be sent to the first sharing object indicated by the sharing operation in response to the sharing operation on the share control.

Here, the third sharing card associated with the first multimedia resource may be a card configured for the first multimedia resource to introduce relevant information of the first multimedia resource, so as to carry the relevant information of the first multimedia resource through the third sharing card, thereby enabling other users to quickly learn the relevant information of the first multimedia resource through the third sharing card in the sharing process of the first multimedia resource.

Exemplarily, the third sharing card may include text information and/or image information related to the first multimedia resource.

For example, the third sharing card may carry a QR code for jumping to a display page of the first multimedia resource and/or a landing page associated with the first multimedia resource. The user may directly jump to the display page of the first multimedia resource and/or the landing page associated with the first multimedia resource by scanning the QR code. For another example, the third sharing card may carry a text and/or a product image for describing a product introduced by the third multimedia resource, so that the user can quickly obtain the relevant information of the first multimedia resource.

In some embodiments, the third sharing card may be obtained based on the second sharing card. The third sharing card may include the second sharing card, and the third sharing card may differ in style from the second sharing card corresponding to the third sharing card.

It should be noted that the third sharing card obtained based on the second sharing card may also include text information and/or image information related to the first multimedia resource. It should be noted that the third sharing card may be the same as or different from the fourth sharing card.

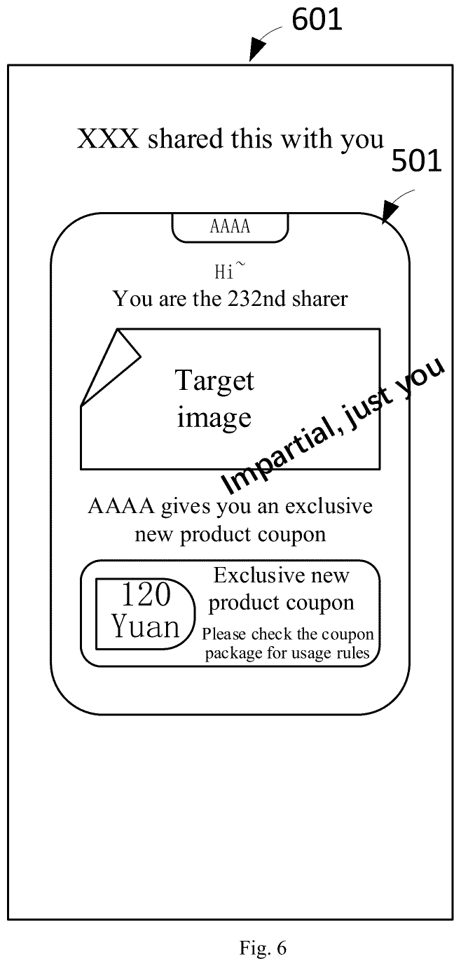

FIG. 6 is a schematic diagram of the third sharing card according to some embodiments. As shown in FIG. 6, the third sharing card 601 may include the second sharing card 501. That is, the third sharing card 601 may be a card obtained based on the second sharing card 501 for displaying the obtained rewards to other users.

When sending the first multimedia resource to the first sharing object, the third sharing card obtained based on the second sharing card may be simultaneously sent to the first sharing object, so as to share the rewards obtained by the present user account through the first multimedia resource with other user accounts through the third sharing card.

In this way, by means of sending the first multimedia resource and the third sharing card to the first sharing object, the rewards obtained by the present user account through the first multimedia resource may be shared with other user accounts through the third sharing card, and more information related to the first multimedia resource may be transmitted to other users through the third sharing card.

In some implementable implementations, a second multimedia resource shared by a second sharing object through the first sharing card and a third sharing card associated with the second multimedia resource may be received.

Here, the electronic device may not only receive the second multimedia resource shared by the second sharing object through the first sharing card, but also receive the third sharing card associated with the second multimedia resource. For detailed description of the third sharing card, reference may be made to relevant descriptions of the above embodiments.

In some embodiments, the third sharing card associated with the second multimedia resource may be obtained based on the second sharing card corresponding to the second multimedia resource.

For example, user A may share the first multimedia resource with user B and obtain the second sharing card through the first sharing card displayed in the first multimedia resource. Furthermore, when user A shares the first multimedia resource with user B, user A may also share the third sharing card obtained based on the second sharing card with user B at the same time.

It should be understood that for how to obtain the third sharing card based on the second sharing card, reference may be made to relevant descriptions of the above embodiments, which will not be repeated here.

In this way, by means of receiving the second multimedia resource shared by the second sharing object through the first sharing card and the third sharing card associated with the second multimedia resource, not only the interaction forms can be enriched, but also the user who receives the shared content can learn about the second multimedia resource through the third sharing card, thereby increasing the display probability of the second multimedia resource.

In some implementable implementations, in step 140, the first multimedia resource may be sent to the first sharing object in response to moving the first sharing card to the first sharing object in the share control.

Here, the sharing operation may be moving the first sharing card to any first sharing object in the share control. The share control may include one or more first sharing objects. When detecting that the user moves the first sharing card to any first sharing object in the share control, the electronic device sends the first multimedia resource and/or the corresponding second sharing card to the first sharing object.

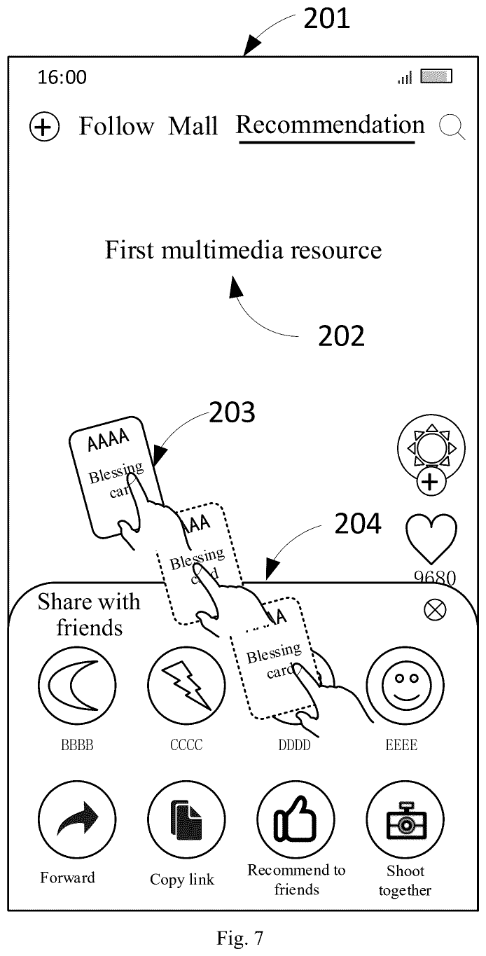

FIG. 7 is a schematic diagram of sending the first multimedia resource to the first sharing object according to some embodiments. As shown in FIG. 7, the user may move the first sharing card 203 to any first sharing object in the share control 204, thereby sharing the first multimedia resource 202 with the corresponding first sharing object. For example, if the user moves the first sharing card 203 to the first sharing object of “DDDD” in the share control 204, the first multimedia resource 202 may be shared with the first sharing object of “DDDD”.

In this way, through the above implementations, the user may share the first multimedia resource with other users by means of moving the first sharing card, which can not only enrich the interactive manner of sharing the multimedia resource, but also increase the user's immersion and make the sharing of the multimedia resource more interesting.

In some implementable implementations, in step 120, when the first multimedia resource is displayed to the preset display node, the first sharing card may be displayed in the target region of the resource display interface for displaying the first multimedia resource.

Here, the preset display node may refer to a resource node in the first multimedia resource. Taking the first multimedia resource as a video as an example, the preset display node of the first multimedia resource may refer to a video node in the video. For example, the preset display node may be the 10th second of the video, that is, the first sharing card is displayed in the video when the video is played to the 10th second.

It should be noted that the position of the preset display node in the first multimedia resource may be determined according to the total duration of the first multimedia resource. Specifically, for a first multimedia resource with a longer total duration, its preset display node may be more backward.

The resource display interface is an interface for displaying the first multimedia resource, and the first sharing card may be displayed in a target region of the resource display interface.

In some embodiments, the target region may be any other region of the resource display interface except a display region for displaying the first multimedia resource. It should be understood that displaying the first sharing card in any other region except the display region for displaying the first multimedia resource may avoid the first multimedia resource from being blocked, thereby ensuring the display integrity of the first multimedia resource.

In some other embodiments, the target region may be a single-handed operation region in the resource display interface. The single-handed operation region refers to a region that can be directly touched by the user when operating the electronic device with a single hand. By displaying the first sharing card in the single-handed operation region of the resource display interface, the user can quickly and directly trigger the first sharing card. It should be understood that the single-handed operation region of the resource display interface may be determined according to a model of the electronic device and/or a gripping manner of the user.

In this way, by means of displaying the first sharing card in the target region, the first multimedia resource can be prevented from being blocked, thereby ensuring the display effect of the first multimedia resource, or enabling the user to quickly and directly share the first multimedia resource with other users through the first sharing card, thereby improving the user experience.

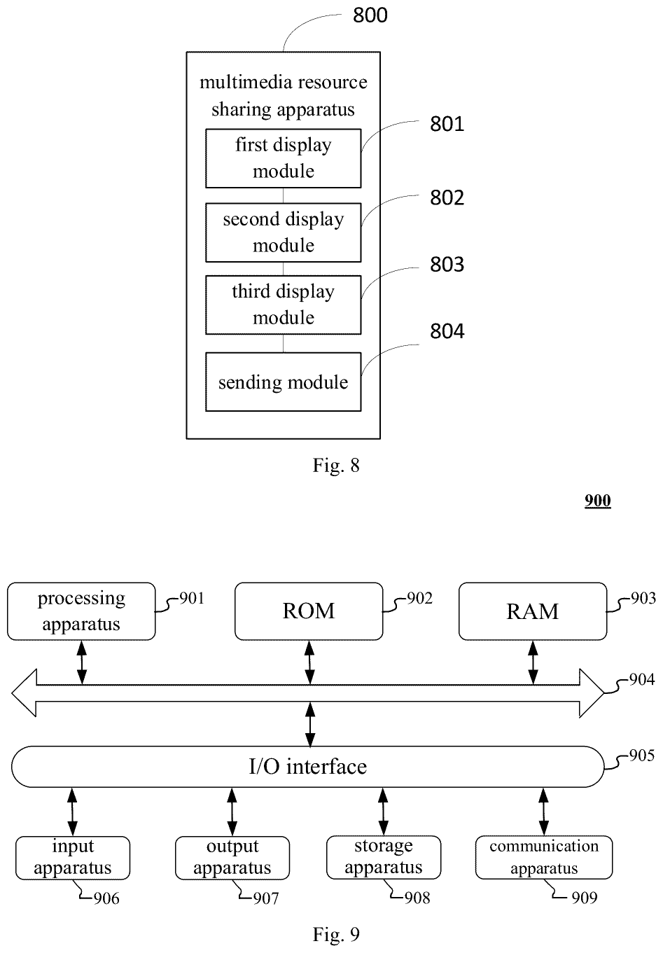

FIG. 8 is a schematic diagram of a structure of a multimedia resource sharing apparatus according to some embodiments. As shown in FIG. 8, an embodiment of the present disclosure provides a multimedia resource sharing apparatus 800, and the multimedia resource sharing apparatus 800 includes:
a first display module 801 configured to display a first multimedia resource;
a second display module 802 configured to display a first sharing card associated with the first multimedia resource in the first multimedia resource;
a third display module 803 configured to display a share control in response to a trigger operation on the first sharing card; and
a sending module 804 configured to send, in response to a sharing operation on the share control, the first multimedia resource to a first sharing object indicated by the sharing operation.

Optionally, the multimedia resource sharing apparatus 800 further includes:
a fourth display module configured to display a second sharing card corresponding to the first sharing card when sending the first multimedia resource to the first sharing object is completed, where the second sharing card includes a target image associated with the first multimedia resource and/or a target object associated with the first multimedia resource.

Optionally, the multimedia resource sharing apparatus 800 further includes:
a saving module configured to save the second sharing card locally in response to a save operation on the second sharing card; and/or
a fifth display module configured to display a page associated with the second sharing card in response to a page jump operation on the second sharing card.

Optionally, the sending module 804 is specifically configured to:
in response to the sharing operation on the share control, send the first multimedia resource and the third sharing card associated with the first multimedia resource to the first sharing object indicated by the sharing operation.

Optionally, the multimedia resource sharing apparatus 800 further includes:
a receiving module configured to receive a second multimedia resource shared by a second sharing object through the first sharing card.

Optionally, the receiving module is specifically configured to:
receive the second multimedia resource shared by the second sharing object through the first sharing card and a third sharing card associated with the second multimedia resource.

Optionally, the sending module 804 is specifically configured to:
in response to moving the first sharing card to the first sharing object in the share control, send the first multimedia resource to the first sharing object.

Optionally, the second display module 802 is configured to:
when the first multimedia resource is displayed to the preset display node, display the first sharing card in the target region of a resource display interface for displaying the first multimedia resource.

The functional logic performed by each functional module in the above multimedia resource sharing apparatus 800 has been explained in detail in the part about the method, and will not be repeated here.

Reference is made to FIG. 9 below, which illustrates a schematic structural diagram of an electronic device (such as a terminal device) 900 suitable for implementing the embodiments of the present disclosure. The terminal device in the embodiments of the present disclosure may include but not be limited to a mobile terminal such as a mobile phone, a notebook computer, a digital broadcast receiver, a personal digital assistant (PDA), a tablet computer (PAD), a portable multimedia player (PMP), a vehicle-mounted terminal (such as vehicle-mounted navigation terminal), and a fixed terminal such as digital a TV, a desktop computer, etc. The electronic device shown in FIG. 9 is only an example, and should not bring any limitation to the functions and scope of use of the embodiments of the present disclosure.

As shown in FIG. 9, the electronic device 900 may include a processing apparatus (e.g., a central processing unit, a graphics processing unit, etc.) 901 that may perform various appropriate actions and processes according to a program stored in a read-only memory (ROM) 902 or a program loaded from a storage apparatus 908 into a random-access memory (RAM) 903. In the RAM 903, various programs and data necessary for the operation of the electronic device 900 are also stored. The processing apparatus 901, the ROM 902, and the RAM 903 are connected to each other through a bus 904. An input/output (I/O) interface 905 is also connected to the bus 904.

Generally, the following apparatuses may be connected to the I/O interface 905: an input apparatus 906 including, for example, a touchscreen, a touchpad, a keyboard, a mouse, a camera, a microphone, an accelerometer, a gyroscope, etc.; an output apparatus 907 including, for example, a liquid crystal display (LCD), a speaker, a vibrator, etc.; the storage apparatus 908 including, for example, a magnetic tape, a hard disk, etc.; and a communication apparatus 909. The communication apparatus 909 may allow the electronic device 900 to perform wireless or wired communication with other devices to exchange data. Although FIG. 9 shows the electronic device 900 having various apparatuses, it should be understood that it is not required to implement or have all of the illustrated apparatuses. More or fewer apparatuses may be implemented or provided alternatively.

In particular, according to the embodiments of the present disclosure, the process described above with reference to the flowchart may be implemented as a computer software program. For example, an embodiment of the present disclosure includes a computer program product, which includes a computer program carried on a non-transitory computer-readable medium, and the computer program includes program codes for executing the method shown in the flowchart. In such an embodiment, the computer program may be downloaded and installed from a network through the communication apparatus 909, or installed from the storage apparatus 908, or installed from the ROM 902. When the computer program is executed by the processing apparatus 901, the above functions defined in the method of the embodiments of the present disclosure are executed.

It should be noted that the above computer-readable medium in the present disclosure may be a computer-readable signal medium, or a computer-readable storage medium, or any combination of the above two. The computer-readable storage medium may be, for example, but not limited to, an electronic, magnetic, optical, electromagnetic, infrared, or semiconductor system, apparatus, or device, or any combination of the above. More specific examples of the computer-readable storage medium may include, but are not limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in combination with an instruction execution system, apparatus, or device. In the present disclosure, the computer-readable signal medium may include a data signal propagated in a baseband or as part of a carrier wave, and computer-readable program codes are carried therein. This propagated data signal may take many forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program for use by or in combination with an instruction execution system, apparatus, or device. The program codes contained on the computer-readable medium may be transmitted by any suitable medium, including but not limited to: a wire, an optical cable, RF (radio frequency), etc., or any suitable combination of the above.

In some implementations, the electronic device may communicate using any currently known or future-developed network protocol, such as HTTP (HyperText Transfer Protocol), and may be interconnected with digital data communication (for example, communication network) in any form or medium. Examples of communication networks include local area networks (“LAN”), wide area networks (“WAN”), international network (for example, the Internet), and end-to-end networks (for example, ad hoc end-to-end networks), as well as any currently known or future-developed networks.

The above computer-readable medium may be included in the above electronic device; or may exist alone without being assembled into the electronic device.

The above computer-readable medium carries one or more programs that, when executed by the electronic device, cause the electronic device to: display a first multimedia resource, display a first sharing card associated with the first multimedia resource in the first multimedia resource, display a share control in response to a trigger operation on the first sharing card, and send the first multimedia resource to a first sharing object indicated by a sharing operation in response to the sharing operation on the share control.

Computer program codes for performing the operations of the present disclosure may be written in one or more programming languages or a combination thereof. The above programming languages include, but are not limited to, object-oriented programming languages such as Java, Smalltalk, C++, and also include conventional procedural programming languages such as “C” language or similar programming languages. The program codes may be executed entirely on a user's computer, partly on a user's computer, as a stand-alone software package, partly on a user's computer and partly on a remote computer, or entirely on a remote computer or a server. In the case of the remote computer, the remote computer may be connected to the user's computer through any kind of network, including a local area network (LAN) or a wide area network (WAN), or may be connected to an external computer (for example, connected through the Internet using an Internet service provider).

The flowcharts and block diagrams in the drawings illustrate possible architecture, function, and operation implementations of the system, method, and computer program product according to various embodiments of the present disclosure. In this regard, each block in the flowcharts or block diagrams may represent a module, a program segment, or a part of codes, and the module, the program segment, or the part of codes contains one or more executable instructions for implementing specified logical functions. It should also be noted that in some alternative implementations, the functions marked in the blocks may also occur in a different order than the order marked in the drawings. For example, two blocks shown in succession may actually be executed substantially in parallel, or may sometimes be executed in a reverse order, which depends on the functions involved. It should also be noted that each block in the block diagrams and/or flowcharts, and the combination of blocks in the block diagrams and/or flowcharts, may be implemented by a dedicated hardware-based system that performs specified functions or operations, or may be implemented by a combination of dedicated hardware and computer instructions.

The modules involved in the embodiments of the present disclosure may be implemented in software or hardware. The name of a module does not constitute a limitation on the module itself under certain circumstances.

The functions described above in this document may be at least partially performed by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD), etc.

In the context of the present disclosure, the machine-readable medium may be a tangible medium that may contain or store a program for use by the instruction execution system, apparatus, or device or in combination with the instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of machine-readable storage media may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an explanation of the applied technical principles. Those skilled in the art should understand that the scope of disclosure involved in the present disclosure is not limited to the technical solutions formed by the specific combination of the above technical features, but also covers other technical solutions formed by any combination of the above technical features or their equivalent features without departing from the above disclosed concept, for example, a technical solution formed by replacing the above features with technical features with similar functions disclosed in the present disclosure (but not limited to).

In addition, although the operations are described in a particular order, this should not be understood as requiring that the operations be performed in the particular order shown or in a sequential order. Under certain circumstances, multitasking and parallel processing may be advantageous. Likewise, although several specific implementation details are included in the above discussion, these should not be construed as limitations on the scope of the present disclosure. Certain features that are described in the context of separate embodiments can also be implemented in combination in a single embodiment. Conversely, various features that are described in the context of a single embodiment can also be implemented in multiple embodiments, either individually or in any suitable sub-combination.

Although the present subject matter has been described in language specific to structural features and/or logical actions of the method, it should be understood that the subject matter defined in the appended claims is not necessarily limited to the specific features or actions described above. Rather, the specific features and actions described above are merely exemplary forms for implementing the claims. With regard to the apparatus in the above embodiments, the specific manner in which each module performs an operation has been described in detail in the method embodiments, and will not be elaborated here.

1. A multimedia resource sharing method, comprising:
displaying a first multimedia resource;
displaying a first sharing card associated with the first multimedia resource in the first multimedia resource;
in response to a trigger operation on the first sharing card, displaying a share control; and
in response to a sharing operation on the share control, sending the first multimedia resource to a first sharing object indicated by the sharing operation.

2. The method according to claim 1, further comprising:
when sending the first multimedia resource to the first sharing object is completed, displaying a second sharing card corresponding to the first sharing card, wherein the second sharing card comprises a target image associated with the first multimedia resource and/or a target object associated with the first multimedia resource.

3. The method according to claim 2, further comprising:
in response to a save operation on the second sharing card, saving the second sharing card locally; and/or in response to a page jump operation on the second sharing card, displaying a page associated with the second sharing card.

4. The method according to claim 2, wherein the in response to the sharing operation on the share control, sending the first multimedia resource to the first sharing object indicated by the sharing operation comprises:
in response to the sharing operation on the share control, sending the first multimedia resource and a third sharing card associated with the first multimedia resource to the first sharing object indicated by the sharing operation.

5. The method according to claim 1, further comprising:
receiving a second multimedia resource shared by a second sharing object through the first sharing card.

6. The method according to claim 5, wherein the receiving the second multimedia resource shared by the second sharing object through the first sharing card comprises:
receiving the second multimedia resource shared by the second sharing object through the first sharing card and a third sharing card associated with the second multimedia resource.

7. The method according to claim 1, wherein the in response to the sharing operation on the share control, sending the first multimedia resource to the first sharing object indicated by the sharing operation comprises:
in response to moving the first sharing card to the first sharing object in the share control, sending the first multimedia resource to the first sharing object.

8. The method according to claim 1, wherein the displaying the first sharing card associated with the first multimedia resource in the first multimedia resource comprises:
when the first multimedia resource is displayed to a preset display node, displaying the first sharing card in a target region of a resource display interface for displaying the first multimedia resource.

9. An electronic device, comprising:
a storage apparatus storing a computer program; and
a processing apparatus configured to execute the computer program in the storage apparatus to implement steps of a multimedia resource sharing method, wherein the multimedia resource sharing method comprises:
displaying a first multimedia resource;
displaying a first sharing card associated with the first multimedia resource in the first multimedia resource;
in response to a trigger operation on the first sharing card, displaying a share control; and
in response to a sharing operation on the share control, sending the first multimedia resource to a first sharing object indicated by the sharing operation.

10. The electronic device according to claim 9, wherein the multimedia resource sharing method further comprises:
when sending the first multimedia resource to the first sharing object is completed, displaying a second sharing card corresponding to the first sharing card, wherein the second sharing card comprises a target image associated with the first multimedia resource and/or a target object associated with the first multimedia resource.

11. The electronic device according to claim 10, wherein the multimedia resource sharing method further comprises:
in response to a save operation on the second sharing card, saving the second sharing card locally; and/or
in response to a page jump operation on the second sharing card, displaying a page associated with the second sharing card.

12. The electronic device according to claim 10, wherein the in response to the sharing operation on the share control, sending the first multimedia resource to the first sharing object indicated by the sharing operation comprises:
in response to the sharing operation on the share control, sending the first multimedia resource and a third sharing card associated with the first multimedia resource to the first sharing object indicated by the sharing operation.

13. The electronic device according to claim 9, wherein the multimedia resource sharing method further comprises:
receiving a second multimedia resource shared by a second sharing object through the first sharing card.

14. The electronic device according to claim 13, wherein the receiving the second multimedia resource shared by the second sharing object through the first sharing card comprises:
receiving the second multimedia resource shared by the second sharing object through the first sharing card and a third sharing card associated with the second multimedia resource.

15. The electronic device according to claim 9, wherein the in response to the sharing operation on the share control, sending the first multimedia resource to the first sharing object indicated by the sharing operation comprises:
in response to moving the first sharing card to the first sharing object in the share control, sending the first multimedia resource to the first sharing object.

16. The electronic device according to claim 9, wherein the displaying the first sharing card associated with the first multimedia resource in the first multimedia resource comprises:
when the first multimedia resource is displayed to a preset display node, displaying the first sharing card in a target region of a resource display interface for displaying the first multimedia resource.

17. A computer-readable medium storing a computer program, wherein the computer program, when executed by a processing apparatus, implements steps of a multimedia resource sharing method, wherein the multimedia resource sharing method comprises:
displaying a first multimedia resource;
displaying a first sharing card associated with the first multimedia resource in the first multimedia resource;
in response to a trigger operation on the first sharing card, displaying a share control; and
in response to a sharing operation on the share control, sending the first multimedia resource to a first sharing object indicated by the sharing operation.

18. The computer-readable medium according to claim 17, wherein the multimedia resource sharing method further comprises:
when sending the first multimedia resource to the first sharing object is completed, displaying a second sharing card corresponding to the first sharing card, wherein the second sharing card comprises a target image associated with the first multimedia resource and/or a target object associated with the first multimedia resource.

19. The computer-readable medium according to claim 18, wherein the multimedia resource sharing method further comprises:
in response to a save operation on the second sharing card, saving the second sharing card locally; and/or
in response to a page jump operation on the second sharing card, displaying a page associated with the second sharing card.

20. The computer-readable medium according to claim 18, wherein the in response to the sharing operation on the share control, sending the first multimedia resource to the first sharing object indicated by the sharing operation comprises:
in response to the sharing operation on the share control, sending the first multimedia resource and a third sharing card associated with the first multimedia resource to the first sharing object indicated by the sharing operation.
